(19) United States
(12) Patent Application Publication
(10) Pub. No.: US 2008/0097020 A1
(43) Pub. Date: Apr. 24, 2008

(54) Blended rubber composition

(76) Inventor: Kenichi Kunieda, Fujisawa (JP)

Correspondence Address: D. Joseph English, Suite 700, 1667 K Street, N.W., Washington, DC, 20006, US

(21) Appl. No.: 11/987,895

(22) Filed: Dec. 5, 2007

(30) Foreign Application Priority Data
Jun. 10, 2005 (JP) 2005-170823
Jun. 10, 2006 (JP) PCT/JP2006/311541

(51) Int. Cl. C08L 9/02; C08K 3/08

(52) U.S. Cl. 524/440; 525/234

(57) ABSTRACT

A blended rubber composition is disclosed, including acrylonitrile-butadiene rubber (NBR) and polymer alloy blended at the ratios of 90-10 wt. percent to 10-90 wt. percent, the polymer alloy being produced by mixed dispersion of methacrylic acid (MMA) into hydrogenated nitrile rubber (HNBR).

### PRIORITY

Filed under 35 U.S.C. §371, this application claims priority under 35 U.S.C. §§119 and 365 of International Application No. PCT/JP2006/311541, filed on Jun. 8, 2006, and from Japanese Patent Application No. 2005-170823, filed on Jun. 10, 2005, the entire disclosures of which are hereby incorporated by reference.

### TECHNICAL FIELD

Presently disclosed embodiments generally relate to blended rubber compositions. More specifically, embodiments relate to blended rubber compositions favorably usable for oil seals, rubber products and sealing parts.

### BACKGROUND

Acrylonitrile-butadiene rubber (NBR) is a synthetic rubber of a copolymer system of acrylonitrile and butadiene. NBR is known to have excellent low-temperature durability, oil resistance and moldability. As such, NBR is used as a sealing material in, for example, oil seals, O-rings, and packing in various industries such as the automobile industry, industrial machinery industry, and others. For example, patent document 1 (Japanese Unexamined Patent Application Publication No. 2001-032845) describes NBR used for a pressure-withstanding Q-ring seal. Additionally, patent document 2 (Unexamined Patent Application Publication No. 2000-017110) describes NBR rubber composition used for seals for vehicles' shock absorbers and assures its slidability.

In recent years, the application of NBR to pressure-withstanding, slidable or maneuverable products has been studied. However, oil seals made from NBR may break in certain cases, resulting in oil leakage. These breaks are due to NBR's shortage of strength and wear resistance. It was difficult to get sufficient wear resistance even when carbon black was compounded with NBR in large quantities to improve the wear resistance.

Non-patent document 1 (Saito, Y., Fujino, A., Ikeda, A. SAE Technical Paper Series, 890359 (1989)) and non-patent document 2 (Rubber Industry Handbook, 4th edition (1994), p. 99, edited by The Society of Rubber Industry, Japan) report that the rubber made by blending hydrogenated acrylonitrile-butadiene rubber (HNBR, a product resulting from selective hydrogenation of only double bond parts of NBR) with ZnO and methacrylic acid (MMA), and crosslinking the blend with peroxide results in high strength and hardness. The rubber obtained from such a polymer alloy demonstrates excellent strength and wear resistance. However, it has a problem in that it is defective in mold lubricity. Therefore, it is not suited for use in sealing materials.

### SUMMARY

It is an object of the various disclosed embodiments provide a blended rubber composition which is easy to mold and demonstrates excellent wear resistance. Another object of the disclosed embodiments is to provide sealing material made from a blended rubber composition which is easy to mold and demonstrates excellent wear resistance.

In one embodiment, a blended rubber composition includes acrylonitrile-butadiene rubber (NBR) and polymer alloy blended at the ratios of 90-10 wt. % to 10-90 wt. %. The polymer alloy is produced by mixed dispersion of methacrylic acid (MMA) into hydrogenated nitrile rubber (HNBR). In another embodiment, the polymer alloy is obtained from dispersing components into hydrogenated nitrile rubber (HNBR), the components including either methacrylic acid (MMA) plus metal zinc or zinc compound, or zinc polymethacrylate. In an alternative embodiment, the polymer alloy has a Carbon-to-Nitrogen (CN) ratio of 18-44 wt. % and an iodine number of 7-56 mg/100 mg. Accordingly, a blended rubber composition with excellent wear resistance and mold lubricity can be obtained.

Additional embodiments include a blended rubber composition used as a sealing material. Accordingly, a blended rubber composition with an excellent sealing effect can be obtained. Further, other embodiments include a blended rubber composition used as a pressure-withstanding, slidable, or maneuverable sealing material. Accordingly, a blended rubber composition is effective as a sealing material used for a pressure-withstanding, slidable, or maneuverable part.

Various aspects of the present disclosure will be or become apparent to one with skill in the art by reference to the following detailed description and examples.

### DETAILED DESCRIPTION

Various embodiments, including preferred embodiments, are presently disclosed.

In various embodiments, acrylonitrile-butadiene rubber having acrylonitrile content ratios of 15-48% is used as NBR. Preferably, the content ratios are 15-35%. Therefore, low nitrile content ratios of 15-24%, medium nitrile content ratios of 25-30%, and/or nitrile content ratios of 31-35% (slightly higher than medium) are preferably usable.

In various embodiments, the polymer alloy is made from mixed dispersion of methacrylic acid (MMA) into hydrogenated nitrile rubber (HNBR). The polymer alloy is preferably obtained by mixed dispersion of components including either methacrylic acid (MMA) plus metal zinc or zinc compound (e.g. zinc oxide), or zinc polymethacrylate into hydrogenated nitrile rubber (HNBR). Mixed dispersion can be effected by a mixer, a homogenizer, a supersonic dispersion device, or other suitable mixing device. Dispersion is preferably made to a high degree.

The polymer alloy preferably has CN content ratios of 18-44 wt. % and iodine numbers of 7-56 mg/100 mg. CN content ratios and iodine numbers within these ranges are preferable because an improved effect in wear resistance can be obtained. Examples of suitable polymer alloys on the market include Zeoforte-ZSC 2395, ZSC 2295, etc. manufactured by Zeon Wear Resistance Corporation.

In various embodiments, compounding ratios of NBR and polymer alloy are 90-10 wt. % to 10-90 wt. %. If the NBR content ratio exceeds 90 wt. % and the polymer alloy content ratio falls below 10 wt. %, mold lubricity will be maintained, but wear resistance will decrease. If NBR content ratio falls below 10 wt. % and polymer alloy content ratio exceeds 90 wt. %, wear resistance will be maintained, but mold lubricity will decrease.

Disclosed embodiments of the blended rubber composition include, as appropriate or if necessary: vulcanization agents, organic peroxides, vulcanization accelerator activators, metal carbonates, metal hydroxides, vulcanization accelerators, antioxidants, softeners and plasticizers, reinforcing agents or fillers, and processing aids.

Examples of suitable vulcanization agents include, but are not limited to, inorganic type vulcanization agents such as sulfur, sulfur monochloride, selenium and tellurium; and organic type vulcanization agents such as sulfur containing compounds, dithiocarbamates and oximes. Examples of suitable organic peroxides include, but are not limited to, dicumyl peroxide, 2,5-dimethyl-2,5-di(t-butylperoxy) hexane, benzoylperoxide, dilauroylperoxide, and 1,3-di(t-butylperoxyisopropyl)benzen. Examples of suitable vulcanization accelerator activators include, but are not limited to, metal oxides such as zinc oxide, active zinc oxide, surface treatment zinc oxide, complex zinc oxide and magnesium oxide. Examples of suitable metal carbonates include, but are not limited to, zinc carbonate. Examples of suitable metal hydroxides include, but are not limited to, calcium hydroxide. Examples of suitable organic type activators include, but are not limited to, stearic acid. Examples of suitable vulcanization accelerators include, but are not limited to, sulfenamide type and thiuram type accelerators. Examples of suitable antioxidants include, but are not limited to, amine type and phenol type antioxidants. Examples of suitable softeners and plasticizers include, but are not limited to paraffinic oil softeners, aromatic oils and naphthenic oils. Examples of suitable reinforcing agents or fillers include, but are not limited to, carbon black and silica. Examples of suitable processing aids include, but are not limited to, lubricants such as stearic acid.

Materials are kneaded using a kneader, an open roll mill, or other suitable device. The kneaded product is vulcanized commonly by press-curing conducted at approximately 150-200° C. for approximately 3-60 minutes. The vulcanized product is commonly vulcanized by oven vulcanization at about 100 to 180° C. for approximately 0.5-5 hours to form a secondary vulcanized product.

In certain embodiments, the blended rubber composition is optionally used as a sealing material. In a preferred embodiment, the blended rubber composition is used as a pressure-withstanding, slidable, or maneuverable sealing material. It is noted that sealing materials include static sealing materials and dynamic sealing materials.

### EXAMPLES

The advantageous effects of various embodiments are further illustrated by the following examples. The components used in these examples included:

NBR (“JSR N251H,” a product of JSR)

Combined acrylonitrile content ratio: 24%, Mooney viscosity: ML₁₊₄(100° C.) 88

Polymer alloy (“ZSC 2395,” a product of Zeon Corporation)

SRF carbon black

Zinc oxide

Stearic acid

Thioester (“KOS-2,” a product of Osaka Organic Chemical Industry Ltd.)

Amine/ketone type antioxidant RD (“NOCRAC 224,” a chemical product of Ouchishinko Chemical Industrial Co., Ltd.)

Alkyl aryl paraphenylene diamine type antioxidant 3C (“NOCRAC 810NA,” a chemical product of Ouchishinko Chemical Industrial Co., Ltd.)

Paraffin wax (melting point: 75° C. or higher)

Sulfur

Thiazole type vulcanization accelerator OM (“NOCCELER DM-P,” a chemical product of Ouchishinko Chemical Industrial Co., Ltd.)

Dithiocarbamate type vulcanization accelerator BZ (“NOCCELER BZ-P,” a chemical product of Ouchishinko Chemical Industrial Co., Ltd.)

“Perbutyl P” (a product of NOF Corporation)

The components were kneaded with a kneader and an open roll mill at the compound ratios shown in Table 1 and vulcanized with a heat press at 180° C. for 10 minutes. The components were then provided with a secondary vulcanization in an oven at 150° C. for 30 minutes to create test pieces (blended rubber composition). The test pieces were used for measurement of properties in a original state and for testing of wear resistance.

Testing and Evaluation—Evaluation of wear resistance by a wear resistance testing method. A surface nature measuring machine manufactured by Shinto Scientific Co., Ltd. was used to reciprocate a SUS steel friction ball of 0.4 mmø and 450 g load 400 times at a travel speed of 400 mm/min for a travel distance of 30 mm. Then a surface roughness/type tester manufactured by Toyo Precision Parts Mfg. Co., Ltd. was used to determine the ten-point roughness height average, R_{z}.

After the testing, wear resistance was evaluated by wear depth according to the following evaluation criteria:

⊚: Wear depth: 30 μm or less;

◯: Wear depth: 30 to 40 μm;

Δ: Wear depth: 40 to 50 μm;

χ: Wear depth: 50 μm or more.

Mold lubricity of vulcanized test pieces was evaluated with a heat press under conditions of 170° C. and 20 minutes according to the following evaluation criteria:

⊚: Best;

◯: Better:

Δ: Good;

X: Bad;

⊚ or ◯ will satisfy required funtions.

TABLE 1

| | | Practical Examples | | | | | | Comparative Exs. | | |
|---|---|---|---|---|---|---|---|---|---|---|
| | | 1 | 2 | 3 | 4 | 5 | 6 | 1 | 2 | 3 |
| NBR (JSR N251H) | | 90 | 80 | 70 | 50 | 30 | 10 | 100 | 100 | — |
| ZSC (ZSC2395) | | 10 | 20 | 30 | 50 | 70 | 90 | — | — | 100 |
| SRF carbon | | 150 | 130 | 110 | 80 | 55 | 30 | 175 | 80 | 10 |
| IISAF Carbon | | — | — | — | — | — | — | — | 65 | — |
| zinc oxide | | 5 | 5 | 5 | 5 | 5 | 5 | 5 | 5 | 5 |
| searic acid | | 2 | 2 | 2 | 2 | 2 | 2 | 2 | 2 | 2 |
| thioester | | 15 | 15 | 15 | 15 | 15 | 15 | 15 | 15 | 15 |
| antioxidant RD | | 1 | 1 | 1 | 1 | 1 | 1 | 1 | 1 | 1 |
| antioxidant 3C | | 1 | 1 | 1 | 1 | 1 | 1 | 1 | 1 | 1 |
| paraffin wax | | 1 | 1 | 1 | 1 | 1 | 1 | 1 | 1 | 1 |
| sulfur | | 0.4 | 0.4 | 0.4 | 0.4 | 0.4 | 0.4 | 0.4 | 0.4 | — |
| vulcanization accelerator DM | | 3.3 | 3.3 | 3.3 | 3.3 | 3.3 | 3.3 | 3.3 | 3.3 | — |
| vulcanization accelerator BZ | | 1.5 | 1.5 | 1.5 | 1.5 | 1.5 | 1.5 | 1.5 | 1.5 | — |
| organic peroxide Perbutyl P | | 2 | 2 | 2 | 2 | 2 | 2 | 2 | 2 | 2 |
| original state | Hs (duroA) | 94 | 94 | 94 | 94 | 94 | 94 | 94 | 94 | 94 |
| | Tb | 23.0 | 24.8 | 26.9 | 29.4 | 32.6 | 34.2 | 17.1 | 22.3 | 35.0 |
| | Eb | 90 | 100 | 110 | 120 | 130 | 140 | 80 | 110 | 150 |

| | | | | | | | | | |
|---|---|---|---|---|---|---|---|---|---|
| result of wear resistance test | ◯ | ⊚ | ⊚ | ⊚ | ⊚ | ⊚ | Δ | X | ⊚ |
| mold lubricity | ⊚ | ⊚ | ⊚ | ⊚ | ⊚ | ◯ | ⊚ | ⊚ | X |

Various disclosed embodiments advantageously provide a blended rubber composition which is easy to mold and has excellent wear resistance. Disclosed embodiments advantageously provide a sealing material made from a blended rubber composition which is easy to mold and has excellent wear resistance.

It may be emphasized that the above-described embodiments, particularly any “preferred” embodiments, are merely possible examples of implementations, merely set forth for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure and the present disclosure and protected by the following claims.

What is claimed is:

1. A blended rubber composition, comprising:
acrylonitrile-butadiene rubber (NBR) and polymer alloy blended at the ratios of 90-10 wt. percent to 10-90 wt. percent, wherein the polymer alloy is produced by mixed dispersion of methacrylic acid (MMA) into hydrogenated nitrile rubber (HNBR).

2. The blended rubber composition of claim 1, wherein the polymer alloy is produced by dispersion into hydrogenated nitrile rubber (HNBR) of components selected from one of methacrylic acid (MMA) plus metal zinc or zinc compound, or zinc polymethacrylate.

3. The blended rubber composition of claim 1, wherein the polymer alloy has CN content ratios of 18 to 44 wt. percent and iodine numbers of 7 to 56 mg/100 mg.

4. The blended rubber composition of claim 2, wherein the polymer alloy has CN content ratios of 18 to 44 wt. percent and iodine numbers of 7 to 56 mg/100 mg.

5. The blended rubber composition of claim 1, wherein the blended rubber composition is used as a sealing material.

6. The blended rubber composition of claim 2, wherein the blended rubber composition is used as a sealing material.

7. The blended rubber composition of claim 3, wherein the blended rubber composition is used as a sealing material.

8. The blended rubber composition of claim 4, wherein the blended rubber composition is used as a sealing material.

9. The blended rubber composition of claim 5, wherein the blended rubber composition is used as one of a pressure-withstanding sealing material, a slidable sealing material, and a maneuverable sealing material.

10. The blended rubber composition of claim 6, wherein the blended rubber composition is used as one of a pressure-withstanding sealing material, a slidable sealing material, and a maneuverable sealing material.

11. The blended rubber composition of claim 7, wherein the blended rubber composition is used as one of a pressure-withstanding sealing material, a slidable sealing material, and a maneuverable sealing material.

12. The blended rubber composition of claim 8, wherein the blended rubber composition is used as one of a pressure-withstanding sealing material, a slidable sealing material, and a maneuverable sealing material.

13. A method of making a blended rubber composition, comprising:
mixing methacrylic acid (MMA) with hydrogenated nitrile rubber (HNBR), thereby forming a polymer alloy;
kneading the polymer alloy with acrylonitrile-butadiene rubber (NBR) at ratios of 90-10 wt. percent to 10-90 wt. percent, thereby forming a kneaded product; and
vulcanizing the kneaded product.

14. The method of claim 13, wherein the step of mixing further includes dispersing into HNBR one of zinc polymethacrylate or an MMA-zinc material, the MMA-zinc material including MMA and zinc or zinc compound.

15. The method of claim 13, wherein the polymer alloy has CN content ratios of 18 to 44 wt. percent and iodine numbers of 7 to 56 mg/100 mg.

16. The method of claim 13, further comprising:
forming a sealing material using the blended rubber composition.

17. The method of claim 16, wherein the sealing material is one of a pressure-withstanding material, a slidable material, or a maneuverable sealing material.

18. A blended rubber composition, comprising:
a polymer alloy produced by mixed dispersion of one of methacrylic acid (MMA) into hydrogenated nitrile rubber (HNBR); and
acrylonitrile-butadiene rubber (NBR), the polymer alloy and NBR being blended at ratios of 90-10 wt. percent to 10-90 wt. percent.

19. The blended rubber composition of claim 18, wherein the polymer alloy is produced by mixed dispersion of either
i) methacrylic acid (MMA) and one of metal zinc or zinc compound; or
ii) zinc polymethacrylate into hydrogenated nitrile rubber (HNBR).

20. The blended rubber composition of claim 18, wherein the polymer alloy has CN content ratios of 18 to 44 wt. percent and iodine numbers of 7 to 56 mg/100 mg.
